(19) United States
(12) Patent Application Publication
(10) Pub. No.: US 2013/0321526 A1
(43) Pub. Date: Dec. 5, 2013

(54) ATTACHING ARRANGEMENT FOR INK ABSORBING MEMBER AND IMAGE FORMING APPARATUS

(71) Applicant: NK WORKS CO., LTD., Wakayama (JP)

(72) Inventors: Nobuaki NAKAOKA, Wakayama (JP); Akihito YAMAMOTO, Wakayama (JP)

(73) Assignee: NK WORKS CO., LTD., Wakayama (JP)

(21) Appl. No.: 13/897,962

(22) Filed: May 20, 2013

(30) Foreign Application Priority Data
May 31, 2012 (JP) 2012-125121

(51) Int. Cl. B41J 2/17

(52) U.S. Cl. CPC B41J 2/1721
USPC 347/31

(57) ABSTRACT

A platen defines a groove in which an ink absorbing member can be fitted. The ink absorbing member forms a pressed portion. There is provided a fixing member for pressing pressed portions of a plurality of ink absorbing members fitted in the groove, thereby fixing these ink absorbing members. The fixing member is configured to assume a fixing posture when the fixing member presses the plurality of ink absorbing members appropriately.

### BACKGROUND OF THE INVENTION

1. Field of the Invention

The present invention relates to an attaching arrangement for an ink absorbing member to be attached to a platen of an ink jet type image forming apparatus and also to an image forming apparatus using the arrangement.

2. Description of the Related Art

When a printing is effected by an ink jet image forming apparatus on an entire surface of a recording medium, some amount of ink will be discharged also to the outside of the recording medium, so there is the possibility of this ink being adhered to the recording medium inadvertently. In such case, the quality of the print will be impaired. Therefore, it is necessary to avoid adhesion of unnecessary ink to the recording medium.

In an attempt to overcome the above problem, it is conventionally effected to attach an ink absorbing member such as one disclosed in the Japanese Unexamined Patent Application Publication No. 2011-068070 to the platen of the ink jet image forming apparatus. Such ink absorbing member is attached to a position corresponding to the width of the recording medium, so that the ink absorbing member may absorb an amount of ink discharged to the outside of the recording medium, thereby to prevent adherence of unnecessary ink to the recording medium.

As such ink absorbing member will accumulate therein an amount of ink in accordance with the repeated cycles of printing operations, there is a need to remove the ink adsorbed in the ink absorbing member at an appropriate timing. For this reason, according to the Japanese Unexamined Patent Application Publication No. 2011-068070, the ink absorbing member is provided with an electrode for generating an electro-osmotic flow to the back side thereof. With this electro-osmotic flow, the amount of ink adsorbed in the ink absorbing member is guided to a waste ink container.

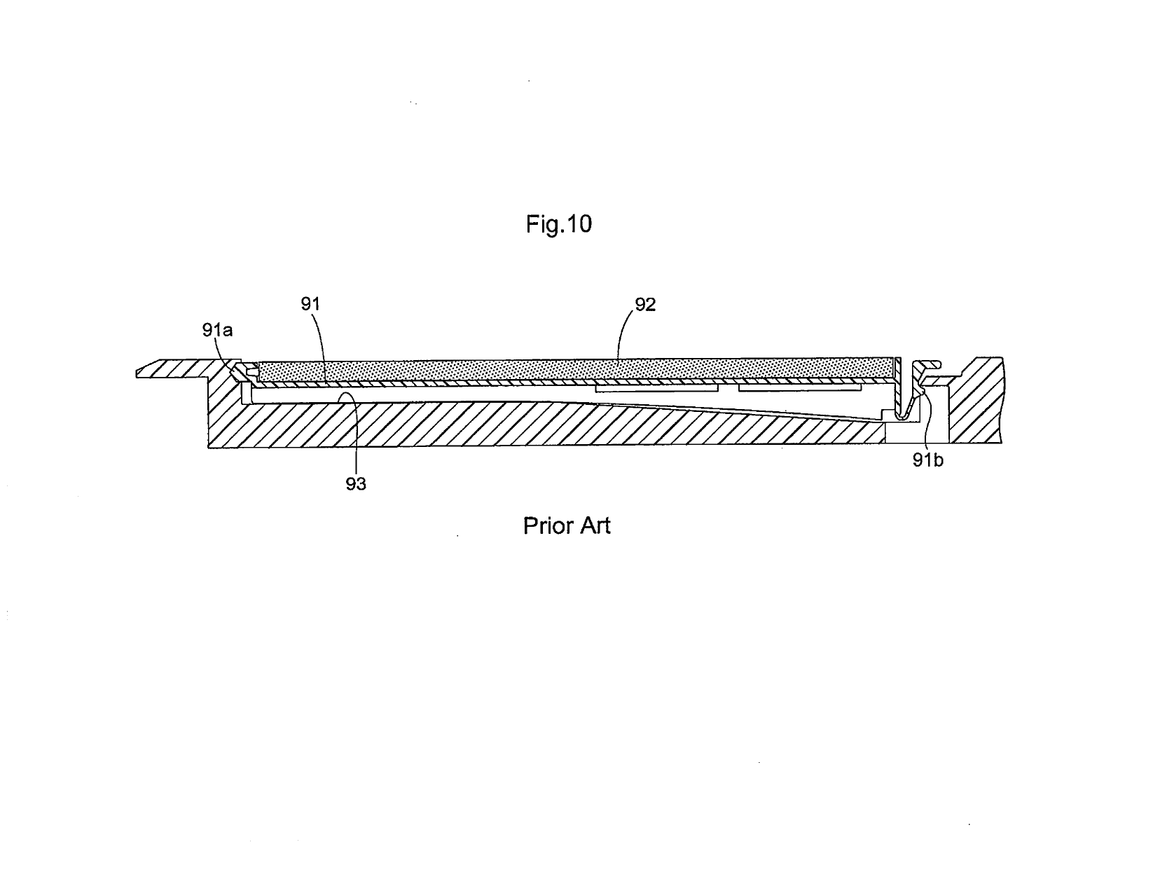

On the other hand, for overcoming the above problem, there is also known an arrangement wherein the ink absorbing member is configured to be detachably attachable, as shown in FIG. 10. With this arrangement, there is no need for providing any additional mechanism as required in the Japanese Unexamined Patent Application Publication No. 2011-068070. With the attaching arrangement for ink absorbing member illustrated in FIG. 10, in the platen, there is defined a groove 93 so that an ink absorbing member 90 formed of an ink absorbent 92 and supported to a support 91 may be engaged therein. At a first end portion of this support 91, there is formed a retaining projection 91a and at a second end portion of the same, there is formed a retaining pawl 91b. On the other hand, at a first end of the groove 93, there is formed a recess for retaining the retaining projection 91a and at a second end of the groove, there is formed a retaining portion for retaining the retaining pawl 91b. As the support 91 is fitted in the groove 93, the retaining projection 91a is retained within the recess and the retaining pawl 91b is retained to the retaining portion. With these, the ink absorbing member 90 can be fixed. In the case of the attaching arrangement of the ink absorbing member illustrated in FIG. 10, if the ink absorbing member is detached after each predetermined period and cleaned and dried, excessive accumulation of ink in the ink absorbent can be prevented.

In general, with an ink jet type image forming apparatus, the gap between the print head and the recording medium is very small (e.g. 2 to 3 mm). Therefore, if a printing operation is effected under a condition of the attachment of the ink absorbing member being not appropriate and the ink absorbing member projecting upwards from the platen resultantly, the ink absorbing member may accidentally come into contact with the print head, thus damaging this head.

In view of the above-described state of the art, an object of the present invention is to provide an attaching arrangement for an ink absorbing member that allows reliable attachment of the ink absorbing member and to provide an image forming apparatus using this arrangement.

### SUMMARY OF THE INVENTION

According to one preferred embodiment of an attaching arrangement for an ink absorbing member relating to the present invention, there is provided an attaching arrangement for an ink absorbing member to be attached to a platen of an image forming apparatus for forming an image on a recording medium by discharging an amount of ink on the recording medium,
wherein the ink absorbent member includes a pressed portion;
the platen includes a groove in which the ink absorbing member can be fitted;
there is provided a fixing member for pressing the pressed portions of a plurality of the ink absorbing members fitted in the groove and fixing these plural ink absorbing members; and
the fixing member is configured to assume a fixing posture when the fixing member presses the plurality of ink absorbing members appropriately.

With the above-described arrangement, the fixing member presses pressed portions of a plurality of ink absorbing members fitted in the groove defined in the platen. With this, the plurality of ink absorbing members are fixed altogether by the fixing member. In this, the fixing member is configured to assume a fixing posture if the fixing member presses the plurality of ink absorbing members appropriately. Therefore, by determining whether the fixing member assumes the fixing posture or not, it is possible to detect whether the ink absorbing members are attached appropriately or not. As a result, attachment error of the ink absorbing members can be prevented. Incidentally, it is advantageous to provide a fixing posture detecting section for detecting whether the fixing member assumes the fixing posture or not. For, this will alleviate the trouble for an operator or the like.

According to a research conducted by the present inventors, it has been found that deterioration occurs in print quality when there exists irregularity in the temperature in the upper face of the platen (the face facing the print head). For this reason, according to one preferred embodiment of the attaching arrangement for an ink absorbing member relating to the present invention, the fixing member is formed of a metal. More preferably, the fixing member and the platen are made from a same metal. With this, it is possible to restrict temperature irregularity in the upper face of the platen.

According to one preferred embodiment of the attaching arrangement for an ink absorbing member relating to the present invention, the ink absorbing member includes an ink absorbent and a support for supporting the ink absorbent, and the pressed portion of the support is curved in the direction opposite to the pressing direction by the fixing member.

If the pressing force applied to the pressed portion is too large, the support will be bent in the pressing direction, so that the terminal end of the ink absorbing member may project upwards, that is, toward the side of the print head. In this case, the projecting ink absorbing member may come into contact with the print head, thus damaging this print head. On the other hand, if the support is configured as described above, bending of the support in the pressing direction can be prevented, so that projecting of the terminal end of the ink absorbing member toward the side of the print head can be prevented.

According to one preferred embodiment of an image forming apparatus relating to the present invention, an image forming apparatus comprises:

a print head for discharging ink onto a recording medium;

a platen disposed to face the print head and supporting the recording medium; and

an ink absorbing member disposed on the platen;

wherein the ink absorbent member includes a pressed portion;

the platen includes a groove in which the ink absorbing member can be fitted;

there is provided a fixing member for pressing the pressed portions of a plurality of the ink absorbing members fitted in the groove and fixing these plural ink absorbing members; and

the fixing member is configured to assume a fixing posture when the fixing member presses the plurality of ink absorbing members appropriately.

For this image forming apparatus, the additional advantageous configurations described above for the attaching arrangement for the ink absorbing member can be employed similarly.

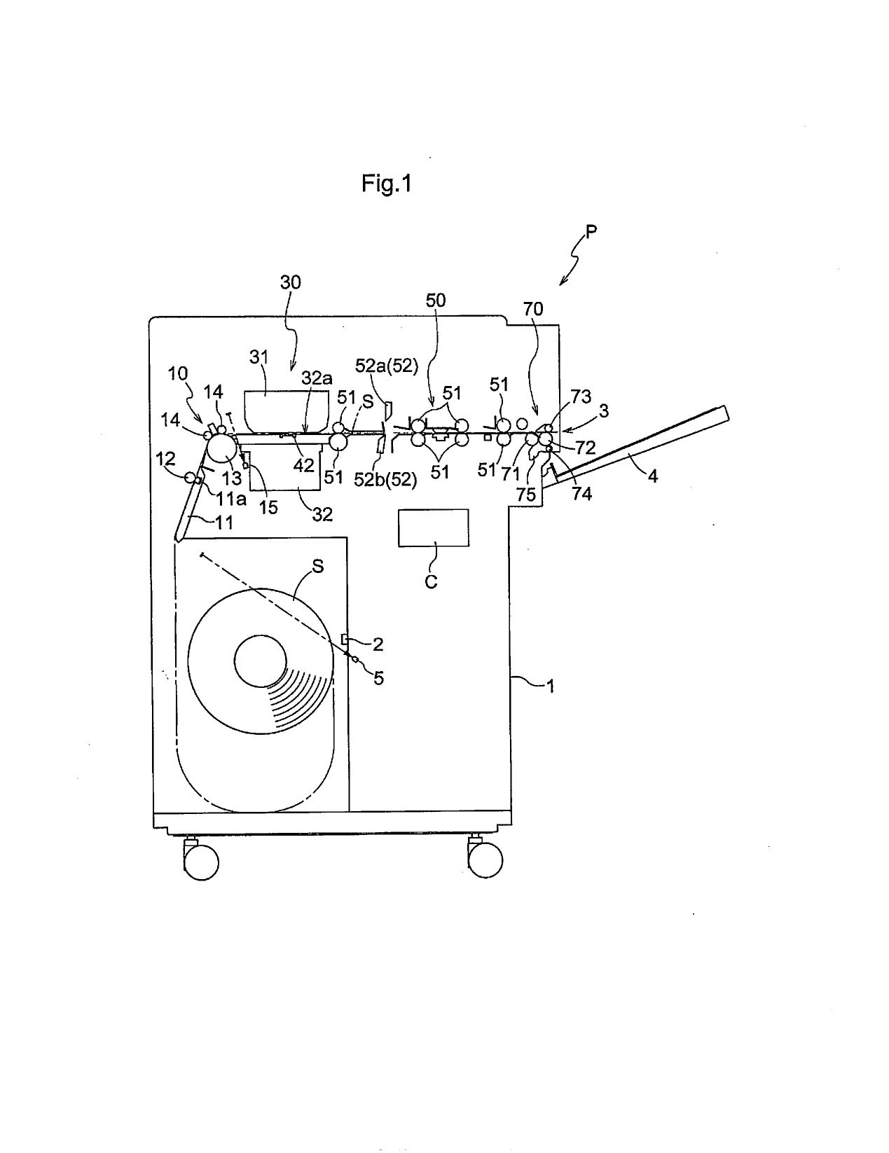

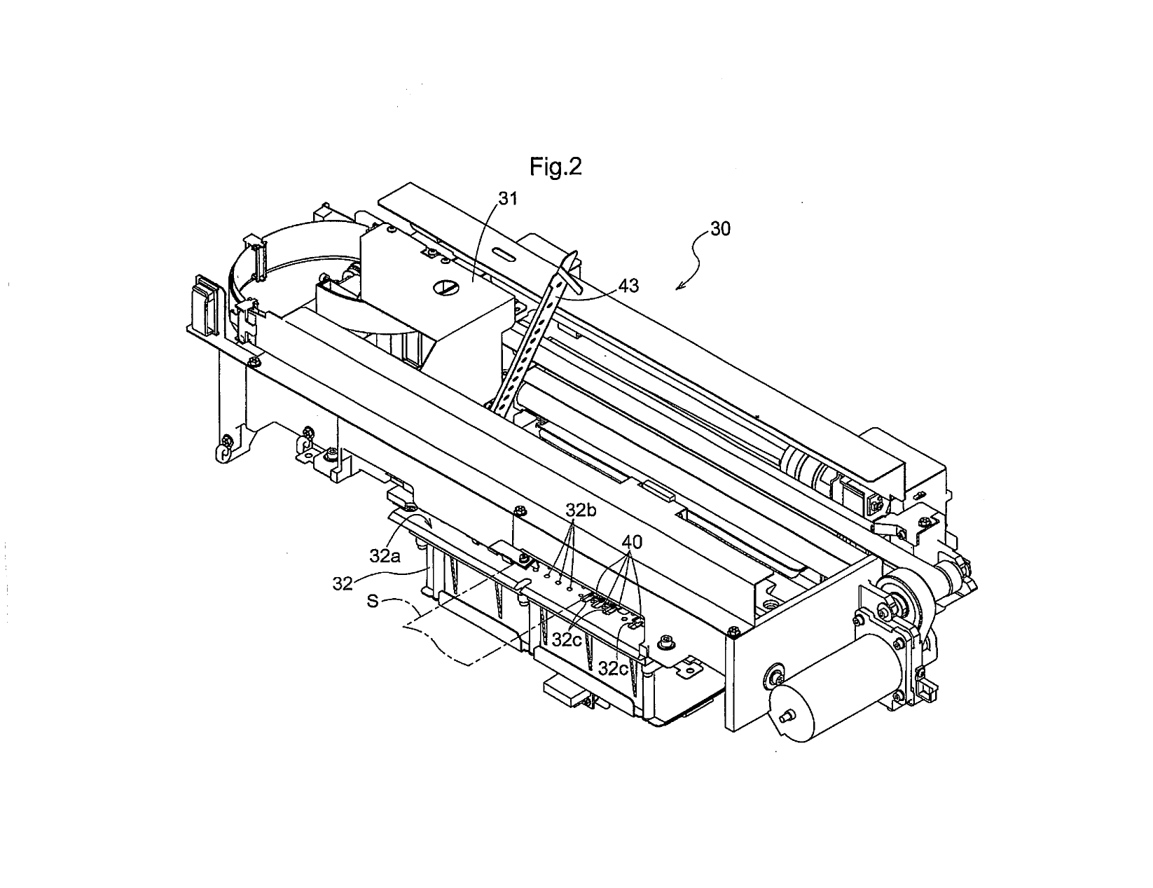

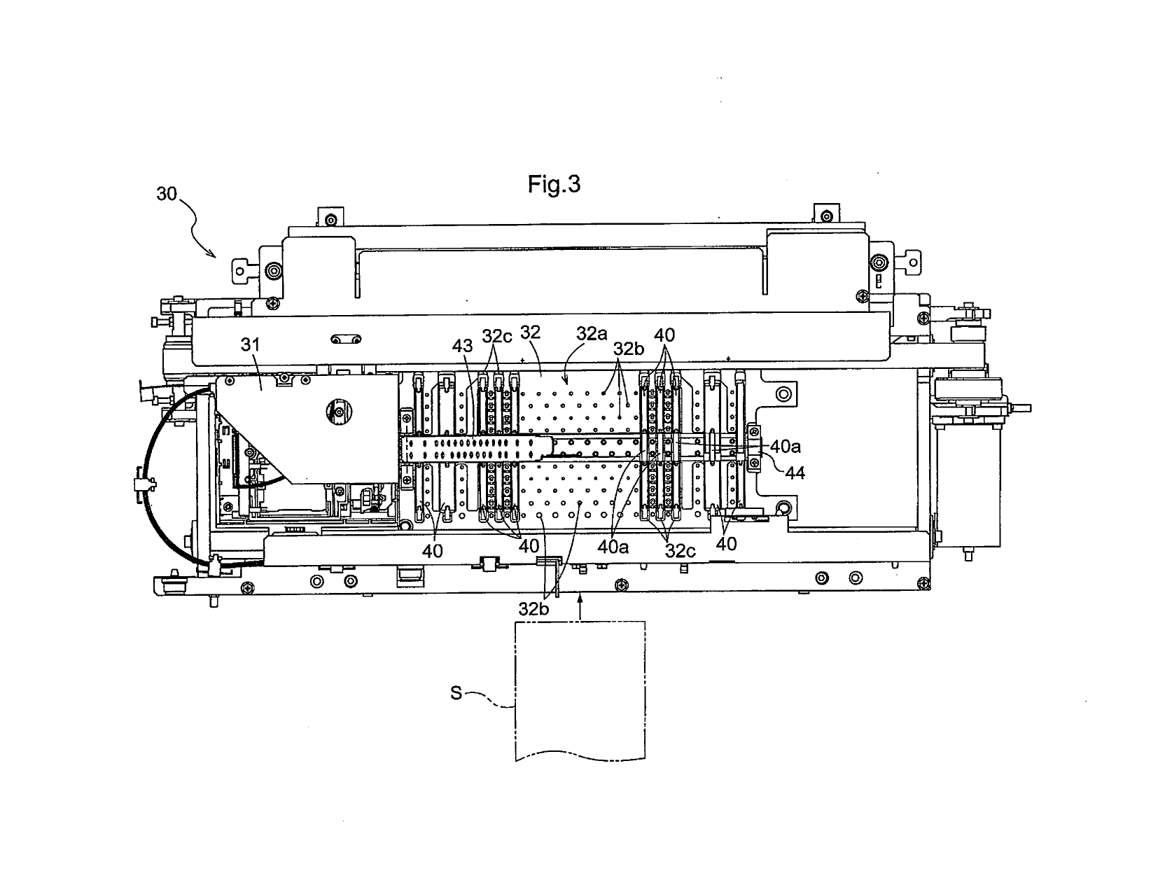

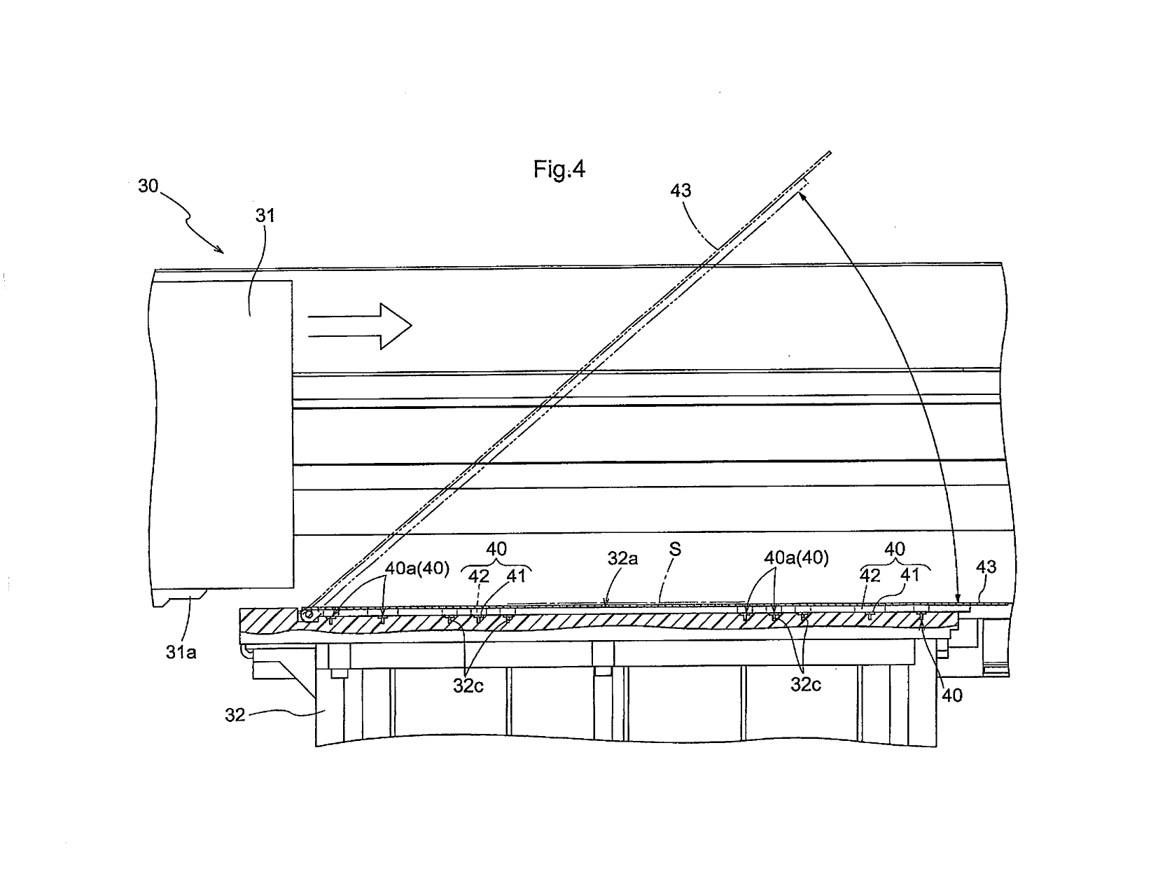

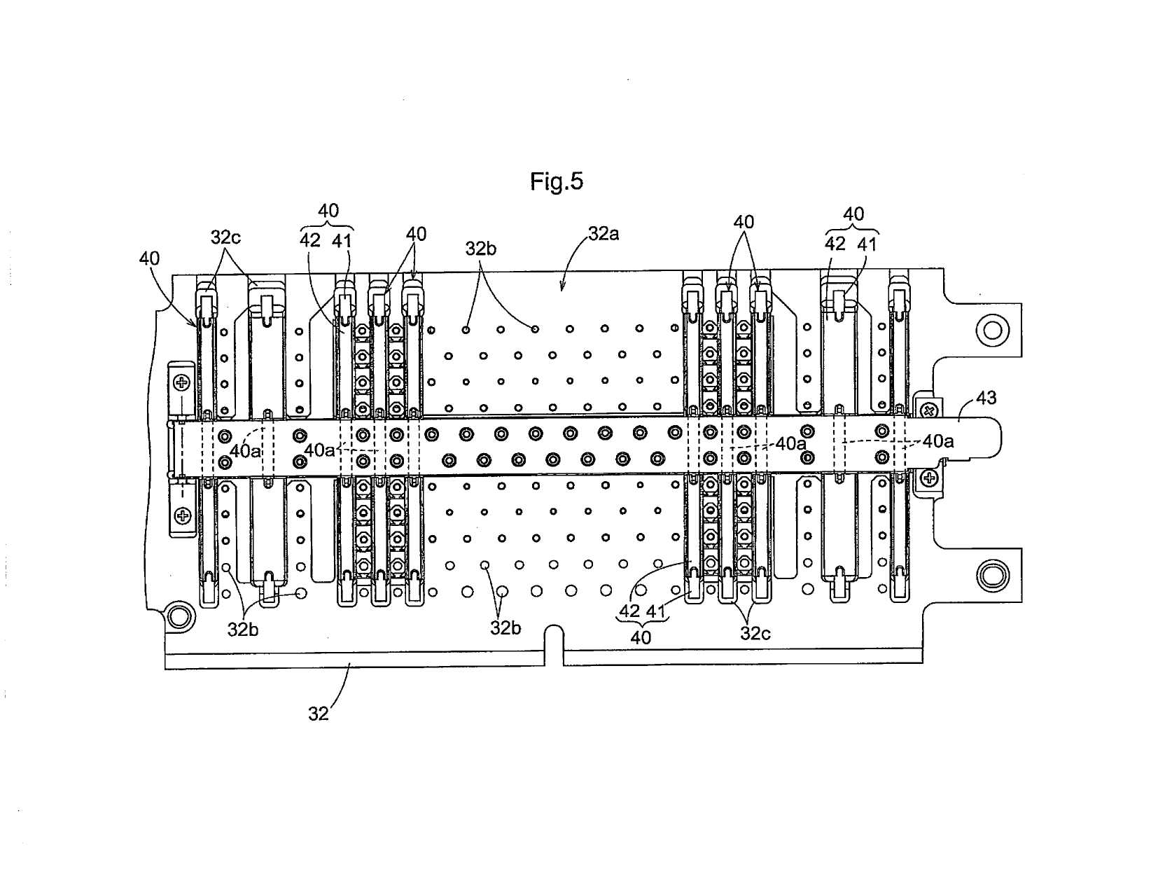

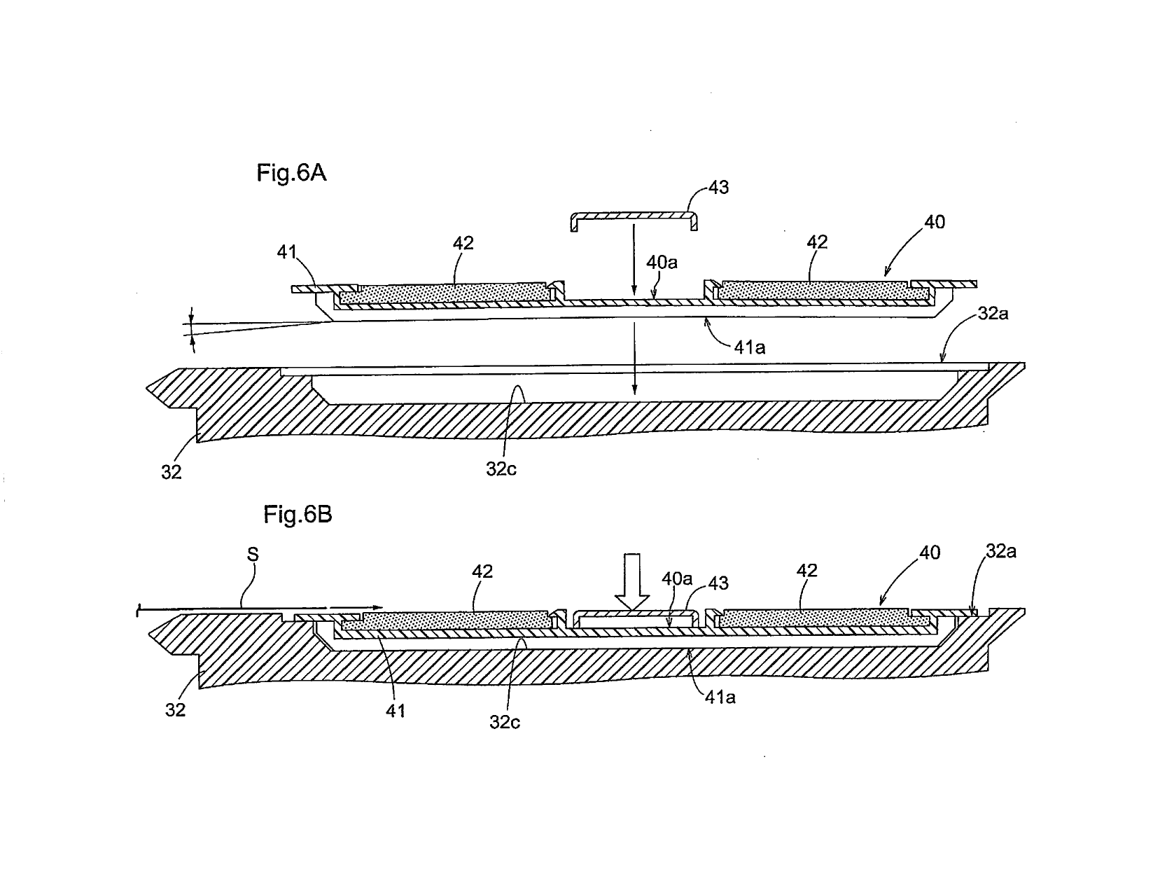

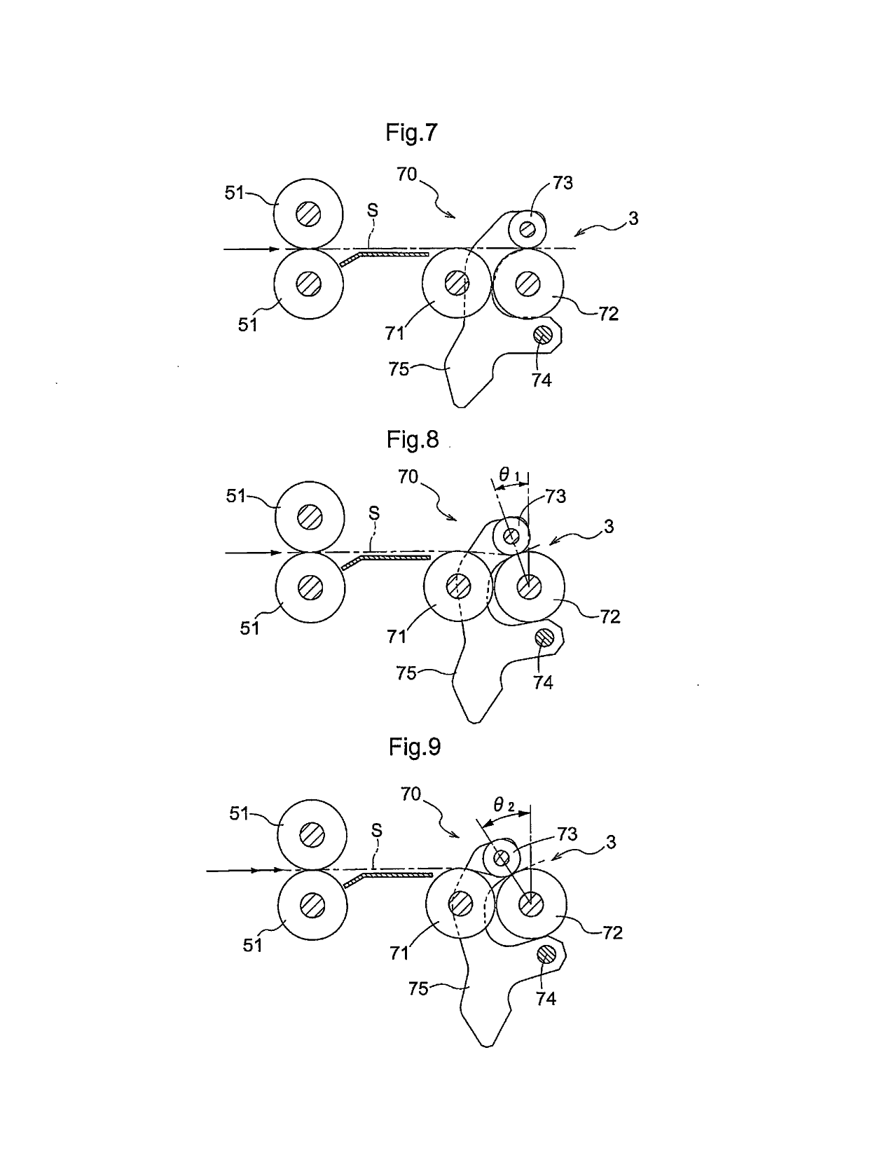

### BRIEF DESCRIPTION OF THE DRAWINGS

[FIG. 1] is a side view in section of an image forming apparatus,

[FIG. 2] is a perspective view of a printing section,

[FIG. 3] is a plane view of the printing section,

[FIG. 4] is a side view in section of the printing section,

[FIG. 5] is a plane view of a platen,

[FIG. 6A] is a view showing a state before attachment of an ink absorbing member,

[FIG. 6B] is a view showing a state after attachment of the ink absorbing member,

[FIG. 7] is a view showing a decurling mechanism under a condition when no decurling operation is effected,

[FIG. 8] is a view showing the decurling mechanism under a condition when a decurling operation is effected,

[FIG. 9] is a view showing the decurling mechanism under a condition when a decurling operation is effected, and

[FIG. 10] is a view showing an attached state of an ink absorbing member relating to the conventional art.

### DETAILED DESCRIPTION OF THE PREFERRED EMBODIMENT

### [General Construction]

Next, an embodiment of the present invention will be explained with reference to the accompanying drawings. FIG. 1 is a side view in section of an image forming apparatus P according to the instant embodiment. The image forming apparatus P according to the embodiment includes a box-like casing 1. Inside the casing 1, there are provided, as seen from the upstream side in the conveying direction, a first conveying section 10, a printing section 30, a second conveying section 50, and a decurling mechanism 70. The conveying section 10 withdraws a recording medium S in the form of a roll and feeds it to the printing section 30. The printing section 30 forms an image on the recording medium S fed thereto. The second conveying section 50 conveys the recording medium S with the recorded image toward the decurling mechanism 70. The decurling mechanism 70 removes curling peculiarity (decurls) of the recording medium S and discharges it through a discharge opening 3.

Inside the casing 1, there is also provided a controlling section C for controlling operations of the entire image forming apparatus P. The controlling section C can be comprised of a CPU or a microcomputer.

### [Recording Medium]

At a lower section inside the casing 1, the recording medium S in the form of a roll is stored. The roll-like recording medium S employed in the instant embodiment is provided with information indicating a serial product number (this will be referred to as “product number information” hereinafter) and in the vicinity of the storage position of the recording medium S, there is provided a product number information reading section 2 for obtaining this product number information. As a means for holding or recording the product number information, a barcode, an RFID tag or the like can be employed. On the other hand, as the product number information reading section 2, there can be employed any device suitable as a means for holding/recording a product number information employed, such as a barcode reader, an RFID reader, etc. The product number information read by the product number information reading section 2 is transmitted to the controlling section C.

Further, inside the casing 1, there is also provided a non-volatile storage medium (not shown) such as a flash memory, accessible from the controlling section C. The non-volatile storage medium stores therein the product number information and property information such as paper quality of the recording medium corresponding to this product number information, in correlation with each other. Accordingly, as the controlling section C obtains product number information from the product number information reading section 2, the controlling section C can obtain the property information of the stored recording medium S.

The image forming apparatus P according to the instant embodiment includes a roll radius (roll diameter) detecting section 5 for detecting a roll radius of the roll-like recording medium S. This roll radius detecting section 5 detects the radius (roll radius) of the recording medium S currently stored and transmits the result to the controlling section C. In the instant embodiment, the roll radius detecting section 5 is comprised of a photo interrupter. The roll radius detecting section 5 determines whether the roll radius of the currently stored recording medium S is greater or smaller than a predetermined value and then transmits the result of this determination to the controlling section C. With this, the controlling section C can recognize the radius of the recording medium S on which an image is to be formed, at the time of its rolled state and the curvature of the recording medium at the time of its rolled state.

### [First Conveying Section]

The first conveying section 10 is provided between the storage position of the recording medium S and the printing section 30 and withdraws the roll-like recording medium S and conveys this toward the printing section 30.

The first conveying section 10 includes a guide member 11 for guiding the recording medium S upwards. The guide member 11 includes a driven roller 11a embedded therein. Further, at a position in opposition to the driven roller 11a, a conveyer roller 12 is provided. In operation, the recording medium S is provided with a conveying force by the conveyer roller 12, thus being conveyed along the guide member 11.

Downstream in the conveying direction of the guide member 11, there are provided an advance roller 13 and two driven rollers 14. In operation, the recording medium S which has been guided from the downward side by the guide member 11 is guided along the horizontal direction by the advance roller 13 and the two driven rollers 14 to be conveyed to the side of the printing section 30.

Between the advance roller 13 and the printing section 30, there is provided a leading end detecting section 15 for detecting the leading end of the recording medium S. This leading end detecting section 15 transmits result of detection of the leading end of the recording medium S to the controlling section C. Then, based on this leading end detection result of the recording medium S, the controlling section C controls the timing of printing operation of the printing section 30. Incidentally, in the instant embodiment, the leading end detecting section 15 comprises a photo interrupter. However, this section 15 may comprise other sensor or the like.

### [Printing Section]

FIG. 2, FIG. 3 and FIG. 4 are a perspective view, a plane view and a side view in section of the printing section 30, respectively. As shown in these drawings, the printing section 30 includes a print head 31 disposed upwardly of the recording medium S which is conveyed thereto, and an absorbing section 31 disposed downwardly of the recording medium S. The print head 31 used in the instant embodiment is configured as an ink jet type print head which includes a plurality of ink discharging sections 31a for discharging ink. In operation, as the print head 31 is moved back and forth in the direction (the transverse direction in FIG. 3) perpendicular to the conveying direction of the recording medium S, the print head 31 discharges an amount of ink onto the recording medium S, thus forming an image on this recording medium S. Incidentally, in the instant embodiment, there are provided two rows of ink discharging sections 31a along the conveying direction of the recording medium S.

Also, as shown in FIG. 3, the absorbing section 32 includes an upper face 32a (the face in opposition to the print head 31) which defines a plurality of opening portions 32b. Through these opening portions 32b, a negative pressure is applied to the recording medium S. Under the effect of this negative pressure, the recording medium S is sucked to the upper face 32a of the absorbing section 32 and rendered flat. Therefore, a printing operation can proceed in a stable manner. Incidentally, the upper face 32a of the absorbing section 32 constitutes a “platen” in the context of the present invention.

### [Second Conveying Section]

As shown in FIG. 1, the second conveying section 50 is disposed downstream of the printing section 30 in the conveying direction. The second conveying section 50 conveys the recording medium S from the printing section 30 via the decurling mechanism 70 toward the discharge opening 3. The second conveying section 50 includes a plurality of pairs of conveyer rollers 51 that pinch and convey the image-formed recording medium S in the horizontal direction. Further, in the conveying path of the second conveying section 50, there is provided a cutter 52 for cutting the image-formed recording medium S into a predetermined size. This cutter 52 includes an upper blade 52a and a lower blade 52b configured to pinch the recording medium S in cooperation therebetween. In operation, as the upper blade 52a is moved vertically, the recording medium S is cut. This cutter 52 is controlled by the controlling section C.

### [Decurling Mechanism]

As described above, as the recording medium S is stored in the form of a roll, the medium S has a curling peculiarity or “a kink”. Though differing depending on the properties of the recording medium S such as the material properties, thickness, etc., in general the curling peculiarity becomes conspicuous when the medium obtains moisture. Namely, when ink is sprayed onto the medium by the printing section 30, the curling peculiarity tends to appear conspicuously. In particular, in the case of a photographic print, the ink is sprayed over the entire surface of the recording medium, the curling peculiarity will appear more conspicuously. The decurling mechanism 70 corrects or removes (decurls) this the curling peculiarity.

As shown in FIGS. 1 through 7 and FIG. 9, the decurling mechanism 70 consists essentially of lower rollers 71, 72 and an upper roller 73. In the instant embodiment, the upper roller 73 is supported to a roller support 75 which is mounted to be pivotable about an axis 74. As shown in FIGS. 7 through 9, the position of the upper roller 73 is varied by controlling the pivot angle of the roller support 75. The roller support 75 is operably connected with an unillustrated power source such as an actuator, a motor, etc., so that with the power from this power source, the pivot angle of the roller support 75 is varied. Further, this power source is configured to be operated based on control signals from the controlling section C.

As shown in FIG. 7, when no decurling operation is effected, the controlling section C controls the power source to pivot the roller support 75 clockwise in the illustration and causes the upper roller 73 to be positioned upwardly of the lower roller 72 disposed on the downstream side in the conveying direction. In this case, the recording medium S is conveyed with no application of decurling effect thereto. On the other hand, when curling peculiarity in the recording medium S is to be corrected (removed), the controlling section C controls the power source to pivot the roller support 75 counterclockwise in the illustration and causes the upper roller 73 to be positioned between the lower rollers 71, 72 (see FIG. 8 and FIG. 9). The pivot angles in FIG. 8 and FIG. 9 are θ₁ and θ₂, respectively and there is a relationship of θ₁<θ₂. Therefore, in the state shown in FIG. 9, the upper roller 73 is located more downwardly, so that a large decurling force can be applied.

As described above, in the instant embodiment, the curvature of the recording medium S to be used when it was coiled can be detected by the curling radius detecting section 5. So, the controlling section C controls the pivot angle of he roller support 75 in accordance with this curvature. Incidentally, the pivot angle of the roller support 75 may be controlled based on such conditions as the paper quality of the recording medium S, an amount of ink used for printing, etc. With such arrangement, a decurling force suitable for the recording medium S can be applied thereto.

The recording medium S decurled by the decurling mechanism 70 is discharged through the discharge opening 3 onto a tray 4.

### [Attaching Arrangement for Ink Adsorbing Member]

When an image is formed on the entire face of the recording medium S with using the print head 31 configured as the ink jet type, there is the possibility of an excess ink being discharged onto the platen. In such case, the ink on the platen may be inadvertently adhered to the recording medium S. For this reason, on the platen, there are mounted ink absorbing members 40 for absorbing ink discharged to the outside of the recording medium S. As shown in FIG. 6A and FIG. 6B, the ink absorbing member 40 has a narrow elongated shape having a longitudinal axis and is mounted such that this longitudinal axis may extend parallel with the conveying direction (the vertical direction in FIG. 3) of the recording medium S. Further, as shown in FIG. 3, along the moving direction (the right-left direction in FIG. 3) of the print head 31, there are attached a plurality of ink absorbing members 40. The attaching positions of the ink absorbing members 40 correspond to the width of the recording medium S that can be stored in the casing 1.

As shown in FIG. 6A and FIG. 6B, the ink absorbing member 40 is comprised of a support 41 and ink absorbents 42 supported to the support 41. In the instant embodiment, the support 41 supports two ink absorbents 42 spaced from each other. The portion between these two ink absorbents is the portion to be pressed by a fixing member 43 which will be described later, which portion constitutes what is referred to as “a pressed portion 40a” in the context of the present invention. Incidentally, it is also possible to employ an arrangement in which the support 41 is configured to support an ink absorbent 42 having a recess at its approximate center in the longitudinal direction. In this case, the recess constitutes the pressed portion 40a. The width of the pressed portion 40a (the width between the ink absorbents 42) is configured to be substantially equal to the width of the fixing member 43 to be described later.

As described above, the ink discharging sections 31a of the print head 31 are provided in two rows and the pressed portions 40a are arranged to be located between these rows of ink discharging sections 31a. Therefore, ink will not be discharged onto these pressed portions 40a (fixing member 43).

The ink absorbents 42 and the support 41 are arranged in symmetry relative to the center in the longitudinal direction. Namely, the ink absorbing member 40 has a symmetric shape. With this, unlike the conventional ink absorbing member 90, there is no need to take the attaching direction/orientation into consideration and attaching error based on the attaching direction/orientation can be avoided.

As shown in FIG. 4, the platen defines a groove 32c in which the ink absorbing member 40 can be fitted. Hence, into this groove 32c, the ink absorbing member 40 will be fitted. The depth of the groove 32c is designed to be substantially equal to the height of the ink absorbing member 40. Therefore, when the ink absorbing member 40 is appropriately fitted in the groove 32c, the upper face of the ink absorbing member 40 becomes approximately flush with the platen. On the other hand, in the case of e.g. the ink absorbing member 40 being not appropriately fitted in the groove 32c, the upper face of the ink absorbing member 40 (the ink absorbent 42) will project upwards from the platen. As shown in FIG. 4, since the distance between the leading end of the ink discharging section 31a and the platen is small (e.g. from 2 to 3 mm), if a printing operation is effected under a condition of the upper end of the ink absorbing member 40 (ink absorbent 42) projecting upwards from the platen, the ink absorbing member 40 (ink absorbent 42) and the ink discharging section 31a may come into contact with each other, whereby the ink discharging section 31a may be damaged thereby. In order to avoid such attaching error of the ink absorbing member, there is provided the fixing member 43.

As shown in FIGS. 2 through 4, the fixing member 43 is provided in the form of a flat plate having a longitudinal axis. The fixing member 43 has its one end side in the longitudinal axis direction supported to the platen. And, the fixing member 43 is configured to be pivotable between a fixing posture (the posture shown with the solid link in FIG. 4) and an opening posture (the posture shown with the two-dot chain line in FIG. 4). When in the fixing posture, the longitudinal axis of the fixing member 43 extends along the moving direction of the print head 31. As shown in FIG. 5, in the instant embodiment, the length of the fixing member 43 in the longitudinal direction is set as a length capable of pressing and fixing all of the ink absorbing members 40 attached to the platen altogether. On the other hand, the width of the fixing member 43 (the length in the direction perpendicular to the longitudinal axis direction) is set to be approximately equal to the width of the pressed portion 40a. Therefore, when the ink absorbing member 40 is fitted in the groove 32c appropriately, if the fixing member 43 is pivoted toward its fixing posture side, the fixing member 43 will engage into the pressed portion 40a of the ink absorbing member 40, thus assuming the fixing posture. The upper face of the fixing member 43 under this fixing posture is substantially in flush with the upper face of the ink absorbing member 40 (ink absorbent 42) and the platen.

On the other hand, when the ink absorbing member 40 is not appropriately fitted, the fixing member 43 will press not the pressed portion 40a, but the ink absorbent 42, so the fixing member 43 cannot engage into the pressed portion 40a. Therefore, an operator or like can visually confirm the fixing member 43 being not under the fixing posture and can recognize that the ink absorbing member 40 is not appropriately attached.

This fixing member 43 is formed of a material which is a metal having a substantially same thermal conductivity as the material forming the platen. By forming the fixing member 43 of such material as above, it is possible to render the heat distribution in the entire surface of the platen uniform when the fixing member 43 is set to the fixing posture.

In the instant embodiment, in order to allow an operator or the like to reliably take notice of whether the fixing member 43 is set under the fixing posture or not, there is provided a fixing posture detecting section 44 (see FIG. 3) for detecting whether the fixing member 43 assumes the fixing posture or not. In the instant embodiment, the fixing posture detecting section 44 is comprised of a photo interrupter. The photo interrupter is disposed adjacent the free end of the fixing member 43 and transmits to the controlling section C a signal indicative of presence/absence of the free end of the fixing member 43. Upon reception from the photo interrupter a signal indicative of the fixing member 43 being not under the fixing posture, the controlling section C will issue an alarm sound or provide a visual sign to that effect on an unillustrated monitor, etc., thereby to allow the operator or the like to be aware of the fixing member 43 not assuming the fixing posture, that is, the ink absorbing member 40 being not appropriately attached. With this, it becomes possible to avoid execution of a printing operation under the condition of the ink absorbing member 40 being not appropriately attached.

Further, as shown in FIG. 6A, in the pressed portion 40a of the support 41, there is formed a curved portion 41a curved upwards. When a pressing force from the fixing member 43 is applied to the curved portion 41a via the pressed portion 40a, as illustrated in FIG. 6B, the curving of the curved portion 41a is eliminated so that the portion becomes straight. With provision of such curved portion 41a in the support 41, when a pressing force from the fixing member 43 is applied to the support 41, it is possible to prevent the longitudinal opposed ends of the support 41 from being displaced upwards in association with downward displacement of the pressed portion of the support 41.

### [Other Embodiments]

(1) The inventive arrangement can omit the fixing posture detecting section 44. Even in the case of omission of the fixing posture detecting section 44, it is still possible by visual inspection whether the fixing member 43 is under the fixing posture or not. Therefore, attachment error of the ink absorbing member 40 can still be avoided.

(2) In the foregoing embodiment, the fixing member 43 is formed of the same material as the platen. Instead, the fixing member 43 may be formed of other metal or any other material.

(3) In the foregoing embodiment, in the support 41, there is formed the curved portion 41a which is curved so as to project to the side opposite the pressing direction of the fixing member 43. However, this curved portion 41a may not be formed.

(4) In the foregoing embodiment, there is employed a roll-like recording medium S. Instead, it is also possible to employ a recording medium S which is cut to a predetermined size in advance.

(5) In the foregoing embodiment, the ink discharging sections 31a are provided in two rows. Instead, these may be provided in three or more rows. In this case, the pressed portion 40a may be disposed at a position corresponding to any one of the space between any adjacent rows.

### INDUSTRIAL APPLICABILITY

The present invention may be applied to an ink jet type image forming apparatus.

1. An attaching arrangement for an ink absorbing member to be attached to a platen of an image forming apparatus for forming an image on a recording medium by discharging an amount of ink on the recording medium,
wherein the ink absorbent member includes a pressed portion;
the platen includes a groove in which the ink absorbing member can be fitted;
there is provided a fixing member for pressing the pressed portions of a plurality of the ink absorbing members fitted in the groove and fixing these plural ink absorbing members; and
the fixing member is configured to assume a fixing posture when the fixing member presses the plurality of ink absorbing members appropriately.

2. An attaching arrangement for an ink absorbing member according to claim 1, further comprising a fixing posture detecting section for detecting whether the fixing member assumes the fixing posture or not.

3. An attaching arrangement for an ink absorbing member according to claim 1, wherein the fixing member is formed of a metal.

4. An attaching arrangement for an ink absorbing member according to claim 1, wherein:
the ink absorbing member includes an ink absorbent and a support for supporting the ink absorbent; and
the pressed portion of the support is curved in the direction opposite to the pressing direction by the fixing member.

5. An image forming apparatus comprising:
a print head for discharging ink onto a recording medium;
a platen disposed to face the print head and supporting the recording medium; and
an ink absorbing member disposed on the platen;
wherein the ink absorbent member includes a pressed portion;
the platen includes a groove in which the ink absorbing member can be fitted;
there is provided a fixing member for pressing the pressed portions of a plurality of the ink absorbing members fitted in the groove and fixing these plural ink absorbing members; and
the fixing member is configured to assume a fixing posture when the fixing member presses the plurality of ink absorbing members appropriately.
